(19) United States
(12) Patent Application Publication
(10) Pub. No.: US 2006/0110161 A1
(43) Pub. Date: May 25, 2006

(54) Method and apparatus for monitoring optical fibers of passive optical network system

(75) Inventors: Yun Hee Cho, Seoul (KR); Kwangjoon Kim, Daejeon-city (KR); Hee Sang Chung, Daejeon-city (KR)

Correspondence Address: MAYER, BROWN, ROWE & MAW LLP, 1909 K STREET, N.W., WASHINGTON, DC, 20006, US

(73) Assignee: ELECTRONICS AND TELECOMMUNICATIONS RESEARCH INSTITUTE

(21) Appl. No.: 11/103,511

(22) Filed: Apr. 12, 2005

(30) Foreign Application Priority Data
Nov. 20, 2004 (KR) 10-2004-0095540

(51) Int. Cl. H04J 14/00

(52) U.S. Cl. 398/72

(57) ABSTRACT

Provided are an apparatus and method for monitoring optical fibers of a passive optical network system including an optical line termination located in a central office, a remote node that is a local office, and optical network units on the subscriber side. The apparatus respectively allocates monitoring light wavelengths to optical network units such that optical fibers of the respective optical network units can be identified and monitored using the monitoring light wavelengths, combines a monitoring light having various wavelengths and a downward optical signal using the WDM coupler, and analyzes signal waveforms of the monitoring light having various wavelengths reflected from the optical network units, to detect the position of a defect generated on an optical line. Accordingly, it is possible to transmit optical signals and monitor the physical states of the optical fibers of the optical network units.

### BACKGROUND OF THE INVENTION

This application claims the priority of Korean Patent Application No. 10-2004-0095540 filed on Nov. 20, 2004, in the Korean Intellectual Property Office, the disclosure of which is incorporated herein in its entirety by reference.

1. Field of the Invention

The present invention relates to a method and apparatus for monitoring optical fibers of a passive optical network system, and more particularly, to a method and apparatus for monitoring optical fibers of a passive optical network system, in which monitors light wavelengths are respectively allocated to optical network units such that a central office can identify and monitor the optical fibers of the optical network units, the central office combines a monitoring light having various wavelengths and a downward optical signal using a WDM coupler and inputs the combined signals to the optical network units, and the signal waveform of monitoring light having different wavelengths, reflected from the respective optical network units, is analyzed, to thereby monitor the physical state of each subscriber optical fiber while transmitting optical signals.

2. Description of the Related Art

FIG. 1 is a block diagram of a conventional passive optical network system. Referring to FIG. 1, a passive optical network includes an optical line termination 110 located in a central office 100, an optical distribution network 130 of a remote node 120 that is a local office, and an optical network unit 140 on a subscriber side.

Passive devices of the passive optical network, in which the optical distribution network 130 is located, include a single optical cable, a passive optical splitter, a connector and splices. Active network devices including the optical line termination 110 and multiple optical network units are located on both ends of the passive optical network.

The optical line termination 110 consists of a transmitter 111, an optical multiplexing/demultiplexing unit 112, and a receiver 113. The transmitter 111 generates a downward optical signal and transmits the downward optical signal. The receiver 113 receives an upward optical signal. The optical multiplexing/demultiplexing unit 112 multiplexes the downward optical signal received from the transmitter 111, demultiplexes the upward optical signal input through the remote node 120 and outputs the upward optical signal to the receiver 113.

The optical network unit 140 includes first through nth optical network units 141 through 14n, as shown in FIG. 1. The first optical network unit 141 consists of a transmitter 161 generating a first upward optical signal and transmitting it, a receiver 171 receiving the downward optical signal, and an optical multiplexing/demultiplexing unit 151 multiplexing the first upward optical signal received from the transmitter 161, outputting the first upward optical signal to the remote node 120, demultiplexing the downward optical signal input through the remote node 120 and outputting the downward optical signal to the receiver 171.

The second optical network unit 142 includes a transmitter 162 generating a second upward optical signal and transmitting it, a receiver 172 receiving the downward optical signal, and an optical multiplexing/demultiplexing unit 152 multiplexing the second upward optical signal received from the transmitter 162, outputting the first upward optical signal to the remote node 120, demultiplexing the downward optical signal input through the remote node 120 and outputting the downward optical signal to the receiver 172.

The nth optical network unit 14n consists of a transmitter 16n generating an nth upward optical signal and transmitting it, a receiver 17n receiving the downward optical signal, and an optical multiplexing/demultiplexing unit 15n multiplexing the nth upward optical signal received from the transmitter 16n, outputting the nth upward optical signal to the remote node 120, demultiplexing the downward optical signal input through the remote node 120 and outputting the downward optical signal to the receiver 17n.

When the optical signal transmitted through the passive optical network is a downward optical signal, that is, the optical signal transmitted from the optical line termination 110 to each optical network unit 140 via the remote node 120, the optical distribution network 130 splits the downward optical signal and transmits the split optical signals to the respective optical network units through optical fibers. When the optical signal transmitted through the passive optical network is an upward optical signal, that is, the optical signals transmitted from the respective optical network units to the optical line termination 110 via the remote node 120, the optical distribution network 130 combines the optical signals and transmits the combined optical signal to the optical line termination 110 through a single optical fiber.

The passive optical network is connected to the optical network units in a point-to-multipoint tree structure using a single optical fiber. The passive optical network is being actively standardized as a technique of economically providing ultra-high speed communication services to subscribers and fierce development competition is being carried out worldwide to secure a passive optical network market. Furthermore, a passive optical network technology model project for studying a system relating to a technique for providing a communication and broadcasting fused service such as a VOD high picture-quality video service and a HDTV broadcasting and ultra-high speed Internet service to subscribers through a single optical cable and service model research is currently being performed.

Therefore, it is important to monitor the physical characteristics of the optical line terminator and optical network units on the subscriber side at all times to detect a problem generated on an optical fiber rapidly and effectively in order to guarantee optical fiber quality. A device used for detecting a defect on an optical fiber is the OTDR (Optical Time Domain Reflectometry).

The OTDR detects and analyzes light back-scattered due to small defects and impurities existing in an optical fiber and light reflected in the optical fiber (reflected on a connector) as a function of time. The OTDR transmits a short impulse propagated from one end of the optical fiber along the optical fiber and measures the quantity of light back-scattered toward a detector as a function of time. If small defects and impurities exist in the optical fiber, a part of light is scattered in all directions. A very sensitive detector measures the quantity of light scattered in a direction opposite to the direction of the impulse. If the quantity of light back-scattered toward the detector is known, it is possible to determine loss distribution in the optical fiber. Accordingly, a loss or a defect at a limited point of the optical fiber will cause temporary discontinuity in back-scattered optical power tracing.

However, in a passive optical network having a tree topology, it is difficult to detect an optical fiber having a defect using the OTDR because back-scattering signals of all of optical fibers are mixed. To solve this problem, Fiber Bragg Gratings that reflect the OTDR monitoring light are placed at the input terminals of the respective optical network units. In this case, however, Fiber Bragg Gratings must be located having different distances from the OTDR. The Fiber Bragg Gratings generate reflection peaks, and temporary discontinuity of the quantity of back-scattering light represents the distance between the OTDR and a defect. The optical fiber having the defect can be detected from the reflection peak.

However, when the Fiber Bragg Gratings do not have different distances from the OTDR, the reflection peaks are mixed and thus it is impossible to detect the optical fiber having the defect. That is, it is required that the lengths of all of the optical fibers are accurately measured such that the Fiber Bragg Gratings located at the input terminals of the optical network units have different distances from the OTDR in the passive optical network system. However, it is very difficult to construct the passive optical network system in this manner.

### SUMMARY OF THE INVENTION

The present invention provides a method and apparatus for monitoring optical fibers of a passive optical network, in which monitoring light wavelengths are respectively allocated to optical network units in advance such that optical fibers of the respective optical network units can be identified and monitored, a central office combines a wavelength-varying OTDR monitoring light and an optical signal and inputs the combined signals to the respective optical network units, and the signal waveform of the monitoring light having different wavelengths reflected from the optical network units is analyzed, to thereby detect the position of a defect generated on an optical fiber.

According to an aspect of the present invention, there is provided an apparatus for monitoring optical fibers of a passive optical network system including an optical line termination, a remote node, and optical network units.

The optical line termination is located in a central office and includes a WDM coupler. The WDM coupler receives a monitoring light having various wavelengths generated by a wavelength-varying OTDR, combines the monitoring light having various wavelengths and a downward optical signal, and outputs the combined monitoring light and downward optical signal to the remote node. In addition, the WDM coupler receives the monitoring light having various wavelengths from the remote node and outputs the monitoring light to the wavelength-varying OTDR. The remote node includes an optical distribution network. The optical distribution network distributes the combined monitoring light having various wavelengths and downward optical signal, received from the optical line termination, to the plurality of optical network units, and outputs the monitoring light received from the optical network units to the optical line termination. Each of the optical network units has a monitoring line reflecting unit. The monitoring light reflecting unit receives the monitoring light having various wavelengths and the downward optical signal from the remote node and, when the monitoring light has a wavelength allocated thereto, reflects the monitoring light having various wavelengths to the optical line termination.

According to another aspect of the present invention, there is provided a method for monitoring optical fibers of a passive optical network system including an optical line termination located in a central office, a remote node that is a local office, and optical network units. The method includes (a) a wavelength-varying OTDR of the optical line termination generating a monitoring light having various wavelengths; (b) a WDM coupler of the optical line termination combining the monitoring light having various wavelengths and a downward optical signal and outputting the combined monitoring light and downward optical signal to the remote node; (c) the remote node distributing the combined monitoring light and downward optical signal to the optical network units; (d) each of the optical network units receiving the monitoring light and downward optical signal and, when the monitoring light has a wavelength allocated thereto, reflecting the monitoring light; and (e) the wavelength-varying OTDR receiving the reflected monitoring light and analyzing the state of the optical fiber of the optical network unit that has reflected the monitoring light.

### BRIEF DESCRIPTION OF THE DRAWINGS

The above and other features and advantages of the present invention will become more apparent by describing in detail exemplary embodiments thereof with reference to the attached drawings in which:

FIG. 1 is a block diagram of a conventional passive optical network system;

FIG. 2 is a block diagram of a passive optical network system including an optical fiber monitoring device according to an embodiment of the present invention;

FIG. 3 shows an example of the waveform of a wavelength-varying OTDR monitoring light;

FIG. 4 shows an example of the signal analysis waveform measured by the wavelength-varying OTDR of FIG. 2; and

FIG. 5 is a flow chart of a method for monitoring optical fibers of the passive optical network system including the optical fiber monitoring device according to an embodiment of the present invention.

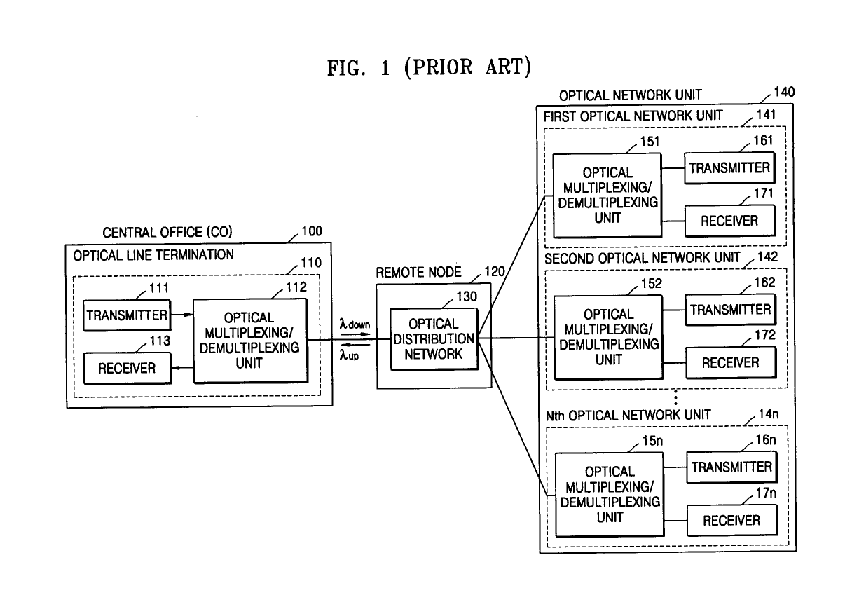

### DETAILED DESCRIPTION OF THE INVENTION

The present invention will now be described more fully with reference to the accompanying drawings, in which exemplary embodiments of the invention are shown. The invention may, however, be embodied in many different forms and should not be construed as being limited to the embodiments set forth herein; rather, these embodiments are provided so that this disclosure will be thorough and complete, and will fully convey the concept of the invention to those skilled in the art. Throughout the drawings, like reference numerals refer to like elements.

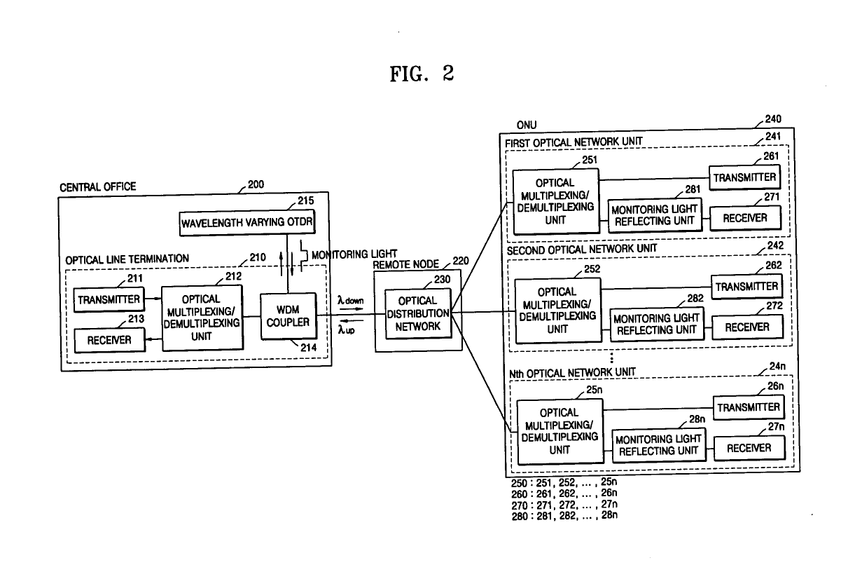

FIG. 2 is a block diagram of a passive optical network system including an optical fiber monitoring device according to an embodiment of the present invention. Referring to FIG. 2, the passive optical network of the present invention includes an optical line termination 210 located in a central office 200, an optical distribution network 230 of a remote node 220 that is a local office, and an optical network unit 240 on a subscriber side.

The optical line termination 210 includes a transmitter 211, an optical multiplexing/demultiplexing unit 212, a receiver 213, a WDM coupler 214, and a wavelength-varying OTDR 215. The transmitter 211 generates a downward optical signal λ_{down} and transmits the downward optical signal. The receiver 213 receives an upward optical signal λᵤₚ. The optical multiplexing/demultiplexing unit 212 multiplexes the downward optical signal received from the transmitter 211, demultiplexes the upward optical signal input through the remote node 220 and outputs the upward optical signal to the receiver 213. The wavelength-varying OTDR 215 generates a monitoring light having various wavelengths, receives and analyzes the monitoring light having different wavelengths, reflected from the optical network unit 240, to detect the position of a defect generated on an optical fiber. The WDM coupler 214 respectively receives the monitoring light having various wavelengths and the multiplexed downward optical signal from the wavelength-varying OTDR 215 and the optical multiplexing/demultiplexing unit 212, combines the monitoring light and downward optical signal outputs the combined signals to the remote node 220. In addition, the WDM coupler 214 receives the monitoring light having various wavelengths reflected from the optical network unit 240 and the upward optical signal, input through the remote node 220, and distributes the reflected monitoring light and the upward optical signal to the wavelength-varying OTDR 215 and the optical multiplexing/demultiplexing unit 212, respectively.

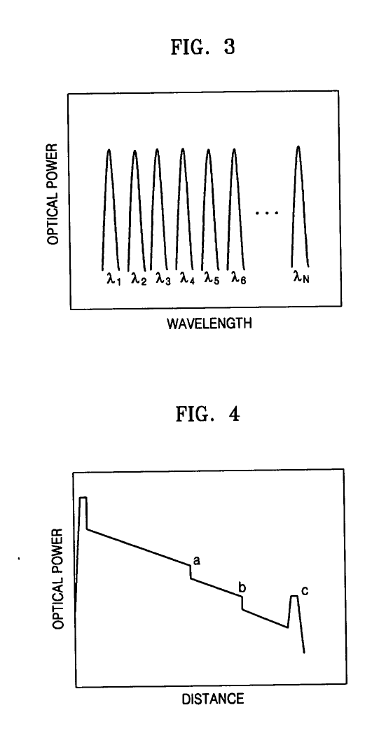

The wavelength-varying OTDR 215 monitors optical fibers of the respective optical network units using the monitoring light having various wavelengths reflected from the optical network units. That is, the present invention uses the wavelength-varying OTDR 215 capable of varying the wavelength of the monitoring light. The wavelengths of the monitoring light generated by the wavelength-varying OTDR 215 are shown in FIG. 3.

FIG. 3 shows an example of the waveform of a wavelength-varying OTDR monitoring light. Referring to FIG. 3, the wavelength of the monitoring light can be varied from λ₁ to λₙ. Here, the wavelength band ranging from λ₁ to λₙ is separated from the bands of the upward optical signal and downward optical signal. The wavelength-varying OTDR 215 respectively allocates the various wavelengths of the monitoring light to the multiple optical network units 240.

Each of the optical network units 240 reflects only the monitoring light wavelength allocated thereto among the wavelengths λ₁ to λₙ. The optical distribution network 230 of the remote node 220 distributes the downward optical signal and the monitoring light having various wavelengths and transmits them to the respective optical network units 240. Here, the downward optical signal and the monitoring light having various wavelengths can pass through a plurality of remote nodes 220 to be transmitted to the optical network units 240.

Furthermore, the optical distribution network 230 of the remote node 220 transmits upward optical signals from the respective optical network units and the monitoring light having various wavelengths reflected from the respective optical network units 240 to the optical line termination 210. Here, the upward optical signals and the monitoring light having various wavelengths can pass through a plurality of remote nodes 220 to be transmitted to the optical line termination 210. The optical distribution network 230 can include a single-wavelength optical cable, a passive optical splitter, a connector and splices.

The optical network unit 240 includes first through nth optical network units 241 through 24n. The first optical network unit 241 includes an optical multiplexing/demultiplexing unit 251, a transmitter 261, a receiver 271, a monitoring light reflecting unit 281. The transmitter 261 generates the upward optical signal λᵤₚ and transmits it. The receiver 271 receives the downward optical signal λ_{down}. The optical multiplexing/demultiplexing unit 251 multiplexes the upward optical signal received from the transmitter 261, demultiplexes the downward optical signal and monitoring light having various wavelengths input through the remote node 220, and outputs the demultiplexed downward optical signal and monitoring light to the receiver 271. The monitoring light reflecting unit 281 is located between the optical multiplexing/demultiplexing unit 251 and the receiver 271 and reflects only the monitoring light having the wavelength allocated to the first optical network unit 241.

The second optical network unit 242 includes an optical multiplexing/demultiplexing unit 252, a transmitter 262, a receiver 272, and a monitoring light reflecting unit 282. The transmitter 262 generates the upward optical signal λᵤₚ and transmits it. The receiver 272 receives the downward optical signal λ_{down}. The optical multiplexing/demultiplexing unit 252 multiplexes the upward optical signal received from the second transmitter 262, demultiplexes the downward optical signal and monitoring light having various wavelengths input through the remote node 220, and outputs the demultiplexed downward optical signal and monitoring light to the receiver 272. The monitoring light reflecting unit 282 is located between the optical multiplexing/demultiplexing unit 252 and the receiver 272 and reflects only the monitoring light having the wavelength allocated to the second optical network unit 242.

The nth optical network unit 24n includes an optical multiplexing/demultiplexing unit 25n, a transmitter 26n, a receiver 27n, and a monitoring light reflecting unit 28n. The transmitter 26n generates the upward optical signal λᵤₚ and transmits it. The receiver 27n receives the downward optical signal λ_{down}. The optical multiplexing/demultiplexing unit 25n multiplexes the upward optical signal received from the nth transmitter 26n, demultiplexes the downward optical signal and monitoring light having various wavelengths input through the remote node 220, and outputs the demultiplexed downward optical signal and monitoring light to the receiver 27n. The monitoring light reflecting unit 28n is located between the optical multiplexing/demultiplexing unit 25n and the receiver 27n and reflects only the monitoring light having the wavelength allocated to the nth optical network unit 24n.

The monitoring light reflecting unit 280 of each optical network unit 240 is located at the input terminal of each optical network unit and reflects only the monitoring light having the wavelength allocated to the corresponding optical network unit but passes the downward optical signal and the monitoring light having wavelengths allocated to the other optical network units.

The monitoring light reflecting unit 280 can be composed of a Fiber Bragg Grating. The Fiber Bragg Grating reflects only the monitoring light having the wavelength allocated to the corresponding optical network unit among signals input through the corresponding optical line but passes the downward optical signal and monitoring lights having wavelengths allocated to the other optical network units to the receiver 270. The monitoring lights reflected from the Fiber Bragg Gratings of the monitoring light reflecting units of the respective optical network units are transmitted to the wavelength-varying ODTR 215 in response to the wavelengths allocated to the optical fibers of the respective optical network units. Accordingly, the wavelength-varying OTDR 215 can identify the optical fibers of the optical network units from the monitoring light wavelengths allocated to the respective optical network units.

Here, the reflection band of the Fiber Bragg Grating must be narrower than the wavelength allocated to the corresponding optical network unit such that the Fiber Bragg Grating can reflect only the monitoring light having the wavelength allocated to the corresponding optical network unit because the Fiber Bragg Grating may reflect monitoring lights having wavelengths adjacent to the wavelength allocated to the corresponding optical network unit in addition to the monitoring light having the wavelength allocated to the corresponding optical network unit.

If the optical fiber of each optical network unit 240 is normally operated, the peak of the signal reflected by the Fiber Bragg Grating of the monitoring light reflecting unit 280 appears on the wavelength-varying OTDR 215. When the optical fiber of the optical network unit 240 has a defect, however, the reflected peak attenuates or disappears. Accordingly, it can be determined whether the optical fiber of a specific optical network unit has a defect. Furthermore, the position of the defect can be detected from temporary discontinuity on the wavelength-varying OTDR 215.

The case where the optical fibers of at least two optical network units have defects will now be explained. When the optical fibers of second and fourth optical network units have defects, for instance, reflection peaks at the monitoring light wavelengths λ₂ and λ₄ are attenuated or temporary discontinuity is observed on the wavelength-varying OTDR 215. Thus, the wavelength-varying OTDR 215 can determine that the optical fibers of the second and fourth optical network units have defects. Therefore, defect positions can be rapidly detected and a period of time required for recovering the defects can be reduced to secure the quality of subscriber optical fibers.

As described above, the present invention can monitor the optical fibers of the optical network units using monitoring lights having different wavelengths. Thus, it is possible to monitor the optical fibers of the respective optical network units even when the optical network units have same distances from the remote node 220.

FIG. 4 shows an example of a signal analysis waveform measured by the wavelength-varying OTDR of FIG. 2. Referring to FIG. 4, ‘a’ and ‘b’ represent decreases in optical power due to distribution of the downward optical signal and the monitoring light having various wavelengths by the optical distribution network 230. In addition, ‘c’ represents the waveform obtained such that the monitoring light allocated to the corresponding optical network unit is reflected by the Fiber Bragg Grating of the monitoring light reflecting unit 280 located at the input terminal of the optical network unit 240 and input to the wavelength-varying OTDR 215.

The passive optical network system is initially installed for normal optical fibers and then the present invention is applied to the optical fibers of the normally operating optical network units to obtain a reference signal analysis waveform. The wavelength-varying OTDR 215 compares the reference signal analysis waveform to the measured signal analysis waveform, as shown in FIG. 4, to observe the state of the optical fibers of the optical network units that reflected the monitoring light.

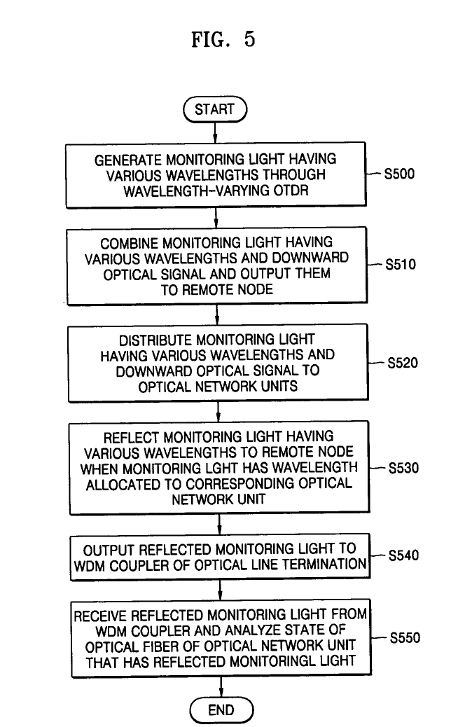

FIG. 5 is a flow chart showing a method for monitoring optical fibers of the passive optical network system including the optical fiber monitoring device according to an embodiment of the present invention. Referring to FIG. 5, the wavelength-varying OTDR 215 of the optical line termination 210 generates a monitoring light having various wavelengths in the step S500. The WDM coupler 214 of the optical line termination 210 combines the monitoring light having various wavelengths and the downward optical signal and outputs the combined signals to the remote node 220 in the step S510.

The optical distribution network 230 of the remote node 220 distributes the combined monitoring light and downward optical signal to the respective optical network units 240 in the step S520. Each of the optical network units receives the monitoring light having various wavelengths and downward optical signal and determines whether the monitoring light has the wavelength allocated thereto. When the monitoring light has the wavelength allocated to the optical network unit, the optical network unit reflects the monitoring light to the remote node 220 in the step S530.

The optical distribution network 230 of the remote node 220 receives the monitoring light having various wavelengths reflected in the step S530 and outputs it to the WDM coupler 214 of the optical line termination 210 in the step S540. Then, the state of the optical network unit that reflected the monitoring light is analyzed using the monitoring light received from the WDM coupler 214 in the step S550.

Before the step S500, the wavelength-varying OTDR 215 allocates different wavelengths to the respective optical network units such that the optical network units can respectively reflect the monitoring light having the wavelengths allocated thereto.

As described above, the present invention respectively allocates monitoring light wavelengths to optical network units such that optical fibers of the respective optical network units can be identified and monitored using the monitoring light wavelengths, combines the monitoring light and the downward optical signal using the WDM coupler, and analyzes the signal waveform of the monitoring light having different wavelengths reflected from the optical network units, to thereby transmit optical signals and, simultaneously, analyze the physical states of the optical fibers of the optical network units.

Accordingly, the position of a defect generated on an optical fiber can be easily detected and a period of time required for repairing the defect can be reduced, and thus the quality of optical fibers of the optical network units can be secured.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. An apparatus for monitoring optical fibers of a passive optical network system comprising:
an optical line termination, which is located in a central office and includes a WDM coupler receiving a monitoring light having various wavelengths generated by a wavelength-varying OTDR, combining the monitoring light having various wavelengths and a downward optical signal, outputting the combined monitoring light and downward optical signal to a remote node, receiving the monitoring light having various wavelengths from the remote node and outputting the monitoring light to the wavelength-varying OTDR;
the remote node including an optical distribution network distributing the combined monitoring light having various wavelengths and downward optical signal, received from the optical line termination, to a plurality of optical network units, and outputting the monitoring light received from the optical network units to the optical line termination; and
the optical network units each having a monitoring light reflecting unit receiving the monitoring light having various wavelengths and the downward optical signal from the remote node and, when the monitoring light has a wavelength allocated thereto, reflecting the monitoring light having various wavelengths to the optical line termination.

2. The apparatus of claim 1, wherein the wavelength-varying OTDR allocates different wavelengths to the respective optical network units and analyzes the states of optical fibers of the optical network units that have reflected the monitoring light having various wavelengths from the monitoring light reflected from the optical network units.

3. The apparatus of claim 1, wherein the optical line termination comprises:
a transmitter generating the downward optical signal;
a receiver receiving an upward optical signal;
an optical multiplexing/demultiplexing unit multiplexing the downward optical signal received from the transmitter and demultiplexing the upward optical signal;
the wavelength-varying OTDR generating the monitoring light having various wavelengths, receiving the monitoring light having various wavelengths reflected from the optical network units and analyzing the received monitoring light to detect the states of the optical fibers; and
the WDM coupler receiving the monitoring light having various wavelengths and the multiplexed downward optical signal from the wavelength-varying OTDR and the optical multiplexing/demultiplexing unit, respectively, combining the monitoring light having various wavelengths and the downward optical signal, outputting the combined monitoring light and downward optical signal to the remote node, receiving the monitoring light having various wavelengths and upward optical signal, reflected from the optical network units and input from the remote node, and distributing the received monitoring light and upward optical signal to the wavelength-varying OTDR and the optical multiplexing/demultiplexing unit, respectively.

4. The apparatus of claim 1, wherein the optical distribution network includes a passive optical splitter.

5. The apparatus of claim 1, wherein the monitoring light reflecting unit is located at the input terminal of each of the optical network units.

6. The apparatus of claim 1, wherein the monitoring light reflecting unit is composed of a Fiber Bragg Grating.

7. The apparatus of claim 6, wherein the reflection band of the Fiber Bragg Grating is narrower than the wavelength allocated to the optical network unit including the Fiber Bragg Grating.

8. A method for monitoring optical fibers of a passive optical network system including an optical line termination located in a central office, a remote node serving as a local office, and optical network units, comprising:
(a) a wavelength-varying OTDR of the optical line termination generating a monitoring light having various wavelengths;
(b) a WDM coupler of the optical line termination combining the monitoring light having various wavelengths and a downward optical signal and outputting the combined monitoring light and downward optical signal to the remote node;
(c) the remote node distributing the combined monitoring light and downward optical signal to the optical network units;
(d) each of the optical network units receiving the monitoring light and downward optical signal and, when the monitoring light has a wavelength allocated thereto, reflecting the monitoring light; and
(e) the wavelength-varying OTDR receiving the reflected monitoring light and analyzing the state of the optical fiber of the optical network unit that has reflected the monitoring light.

9. The method of claim 8, further comprising:
the remote node receiving the reflected monitoring light having various wavelengths and outputting it to the WDM coupler of the optical line termination; and
the WDM coupler outputting the reflected monitoring light having various wavelengths to the wavelength-varying OTDR between the (d) and (e).

10. The method of claim 8, further comprising the wavelength-varying OTDR allocating different wavelengths to the respective optical network units such that the optical network units can reflect the monitoring light having the wavelengths allocated thereto before the (a).

11. The method of claim 8, wherein the monitoring light is reflected by controlling the wavelength of the reflection band of a Fiber Bragg Grating in the (d).
